(19) United States
(12) Patent Application Publication
(10) Pub. No.: US 2016/0343311 A1
(43) Pub. Date: Nov. 24, 2016

(54) DISPLAY DEVICE AND CONTROL METHOD FOR THE SAME

(71) Applicant: CANON KABUSHIKI KAISHA, Tokyo (JP)

(72) Inventors: Kenichi Morikawa, Kawasaki-shi (JP); Takeshi Ikeda, Ebina-shi (JP)

(21) Appl. No.: 15/152,038

(22) Filed: May 11, 2016

(30) Foreign Application Priority Data
May 19, 2015 (JP) 2015-102127
May 19, 2015 (JP) 2015-102128

(51) Int. Cl. G09G 3/36; G09G 3/20

(52) U.S. Cl. CPC G09G 3/36; G09G 3/2003; G09G 2320/0626

(57) ABSTRACT

A display device according to the present invention includes a display unit that displays an image based on an input frame, a light emitting unit including a plurality of light emitting regions whose light emission is separately controllable, and a display controller that controls the light emission of each of the light emitting regions using luminance determined for each of the light emitting regions using the input frame. When the display unit displays a first subframe in which high-frequency components of the input frame are emphasized and a second subframe in which the high-frequency components of the input frame are suppressed by switching therebetween, the display controller applies the luminance determined using the input frame to each of the plurality of light emitting regions during a period for which the first subframe is displayed and a period for which the second subframe is displayed to control the light emission.

### BACKGROUND OF THE INVENTION

1. Field of the Invention

The present invention relates to a display device including a light emitting unit and a control method for the display device.

2. Description of the Related Art

A display device using a transmission type display panel such as a liquid crystal panel includes a display unit that displays an image and a backlight that irradiates the display unit with light from a rear surface side thereof. A light emitting unit including a plurality of regions is capable of controlling luminance in each of the regions depending on luminance characteristics of an input frame. When the luminance is controlled in each of the regions, the contrast ratio of an entire display image is enhanced.

Additionally, the display device using a transmission type display panel such as a liquid crystal panel is called a hold-type display device, in which an afterimage phenomenon occurs with ease. In a case where a similar image is displayed once or multiple times within a single frame period in the hold-type display device, images different from each other are displayed in each frame while a moving image is displayed. At this time, because the display image suddenly changes between frames, a human eye recognizes motion blur due to the afterimage phenomenon in some cases.

Japanese Patent Application Laid-Open No. 2007-304204 discloses a technique for filtering processing carried out for each frame of the input frames to generate a high-frequency emphasized subframe in which high-frequency components are concentrated and a high-frequency suppressed subframe in which the high-frequency components are suppressed, thereby alternately displaying the two subframes. After the high-frequency emphasized subframe is displayed, the high-frequency suppressed subframe is displayed in which the high-frequency components are suppressed in an edge portion or the like where a large change in contrast is observed in a contour or the like where the motion blur is easy to recognize. As a result, the motion blur is improved.

### SUMMARY OF THE INVENTION

A display device according to the present invention includes a display unit configured to display an image on a screen based on an input frame, a light emitting unit including a plurality of light emitting regions whose light emission is separately controllable and configured to irradiate the display unit with light, and a control unit configured to control the light emission of each of the light emitting regions using luminance determined for each of the light emitting regions using the input frame. In the display device, when the display unit displays a first subframe in which high-frequency components of the input frame are emphasized and a second subframe in which the high-frequency components of the input frame are suppressed by switching therebetween, the control unit applies the determined luminance during a period for which the first subframe is displayed and a period for which the second subframe is displayed to control the light emission.

Furthermore, a control method for a display device according to the invention is a control method for a display device including a display unit configured to display an image on a screen based on an input frame, and a light emitting unit including a plurality of light emitting regions whose light emission is separately controllable and configured to irradiate the display unit with light. In a control process that controls the light emission of each of the light emitting regions using luminance determined for each of the light emitting regions using the input frame, when the display unit displays a first subframe in which high-frequency components of the input frame are emphasized and a second subframe in which the high-frequency components of the input frame are suppressed by switching therebetween, the luminance determined using the input frame is applied to each of the plurality of light emitting regions during a period for which the first subframe is displayed and a period for which the second subframe is displayed such that the light emission is controlled.

Further features of the present invention will become apparent from the following description of exemplary embodiments (with reference to the attached drawings).

### BRIEF DESCRIPTION OF THE DRAWINGS

FIG. 1 is a functional block diagram illustrating a display device 1 according to a first embodiment.

FIG. 2 is a lookup table used for conversion between a luminance characteristic and a luminance value according to the first embodiment.

FIG. 3 is a schematic diagram illustrating control regions in a light emitting unit 300 according to the first embodiment.

FIG. 4A is a schematic diagram illustrating a method for determining luminance setting values of respective regions arranged in a horizontal direction, namely, a region B1 to a region B6 according to the first embodiment.

FIG. 4B is a schematic diagram illustrating the method for determining the luminance setting values of the respective regions arranged in the horizontal direction, namely, the region B1 to the region B6 according to the first embodiment.

FIG. 5 is a timing diagram illustrating a timing of each processing until the luminance setting value is determined according to the first embodiment.

FIG. 6A is a schematic diagram illustrating a method for determining the luminance setting values of the respective regions arranged in the horizontal direction, namely, the region B1 to the region B6 according to the first embodiment.

FIG. 6B is a schematic diagram illustrating a method for determining the luminance setting values of the respective regions arranged in the horizontal direction, namely, the region B1 to the region B6 according to the first embodiment.

FIG. 7A is a schematic diagram illustrating a method for determining the luminance setting values of respective regions arranged in the horizontal direction, namely, a region B1 to a region B6 according to a second embodiment.

FIG. 7B is a schematic diagram illustrating the method for determining the luminance setting values of the respective regions arranged in the horizontal direction, namely, the region B1 to the region B6 according to the second embodiment.

FIG. 8 is a functional block diagram illustrating a display device 1 according to a third embodiment.

FIG. 9 is a flowchart for determining an amount of light emission according to the third embodiment.

FIG. 10A is a schematic diagram illustrating a method for determining the amounts of light emission of respective regions arranged in the horizontal direction, namely, a region B1 to a region B6 according to the third embodiment.

FIG. 10B is a schematic diagram illustrating the method for determining the amounts of light emission of the respective regions arranged in the horizontal direction, namely, the region B1 to the region B6 according to the third embodiment.

FIG. 11 is a functional block diagram illustrating the display device 1 according to a variation of the third embodiment.

FIG. 12 is a timing diagram illustrating a timing of each processing until the luminance setting value is determined according to the third embodiment.

FIG. 13 is a flowchart for determining the amount of light emission according to a fourth embodiment.

FIG. 14A is a schematic diagram illustrating a method for determining the amounts of light emission of respective regions arranged in the horizontal direction, namely, a region B1 to a region B6 according to the fourth embodiment.

FIG. 14B is a schematic diagram illustrating the method for determining the amounts of light emission of the respective regions arranged in the horizontal direction, namely, the region B1 to the region B6 according to the fourth embodiment.

### DESCRIPTION OF THE EMBODIMENTS

Hereinafter, embodiments according to the invention will be described with reference to the drawings. Note that the technical scope of the invention is determined based on the scope of patent claims and not construed to be limited to the embodiments exemplified hereinafter. Additionally, all of the combinations of the characteristics described in the embodiments are not necessarily required for the invention. The content described in the present specification and the drawings merely serves as examples and should not be deemed to limit the invention. Various types of modifications (including organic combinations of the several embodiments) can be made based on the scope of the invention and these modifications also should not be excluded from the scope of the invention. Accordingly, each of the configurations combining the several embodiments and variations thereof is of course included in the invention.

### First Embodiment

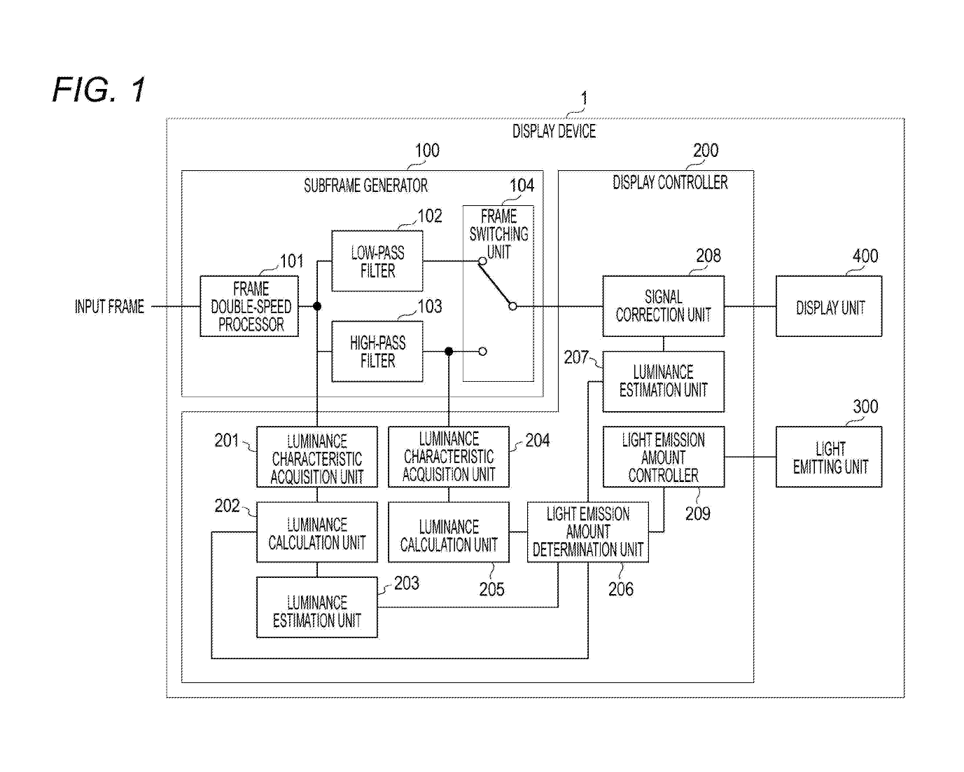

FIG. 1 is a functional block diagram illustrating a display device 1 according to a first embodiment. The display device 1 includes a subframe generator 100, a display controller 200, a light emitting unit 300, and a display unit 400. The subframe generator 100 includes a frame double-speed processor 101, a low-pass filter 102, a high-pass filter 103, and a frame switching unit 104. The display controller 200 includes a luminance characteristic acquisition unit 201, a luminance calculation unit 202, a luminance estimation unit 203, a luminance characteristic acquisition unit 204, a luminance calculation unit 205, a light emission amount determination unit 206, a luminance estimation unit 207, a signal correction unit 208, and a light emission amount controller 209. Functions of the respective members will be described below.

The subframe generator 100 generates, in response to an input frame image, a high-frequency emphasized subframe in which high-frequency components are emphasized and a high-frequency suppressed subframe in which the high-frequency components are suppressed. The generated high-frequency emphasized subframe and high-frequency suppressed subframe are output to the luminance characteristic acquisition unit 201, the luminance characteristic acquisition unit 204, and the signal correction unit 208.

The frame double-speed processor 101 outputs the subframe at a frequency twice a frequency of the input frame. Specifically, the frame double-speed processor 101 writes an image signal of the input frame to a frame memory and then reads the written image signal at the frequency twice the frequency of the input frame. The image signal of the read subframe is input to the low-pass filter 102 or the high-pass filter 103. Note that the double-speed processing has been described here but N-time-speed processing (N>2) such as triple-speed processing and quadruple-speed processing can be also employed.

The low-pass filter 102 carries out low-pass filter processing as processing for passing low frequencies of the image signal of the frame that has been input. With this, low-frequency components are concentrated from a viewpoint of space and then the high-frequency suppressed subframe in which the high-frequency components are suppressed is generated. Meanwhile, the high-pass filter 103 carries out high-pass filter processing as processing for passing high frequencies of the image signal of the frame that has been input in addition to emphasis processing thereof.

With this, the high-frequency components are concentrated from a viewpoint of space and then the high-frequency emphasized subframe in which the high-frequency components are emphasized is generated. In the embodiment, the low-pass filter 102 is used to generate the high-frequency suppressed subframe. However, it is also possible to generate the high-frequency suppressed subframe using a difference between the image signal of the input frame and the image signal of the high-frequency emphasized subframe.

The frame switching unit 104 synchronizes the image signals of the high-frequency emphasized subframe and the high-frequency suppressed subframe output from the low-pass filter 102 and the high-pass filter 103, respectively, with the frequency whose speed has been doubled by the frame double-speed processor to alternately output to the signal correction unit 208.

The display controller 200 uses the input frame along with the high-frequency emphasized subframe and the high-frequency suppressed subframe acquired from the subframe generator 100 to determine a luminance setting value SL1 for the light emitting unit 300, thereby controlling an amount of light emission of the light emitting unit 300. Additionally, the display controller 200 corrects the signals of the respective subframes acquired from the subframe generator 100 based on the luminance setting values SL1 to output to the display unit 400.

The luminance characteristic acquisition unit 201 acquires the image signal of the input frame output from the frame double-speed processor 101. The luminance characteristic acquisition unit 201 acquires, from the acquired image signal of the input frame, the luminance characteristics of respective regions corresponding to a plurality of regions of the light emitting unit 300 described later. In the embodiment, maximum values of gradation values of the respective regions have been defined as the luminance characteristics. For example, in a case where a light source of the light emitting unit 300 is formed with three colors, specifically, red, green, and blue, the largest gradation value among the maximum gradation values of the respective colors can be also used.

In addition to the maximum value, mean values and median values in the respective regions can be also employed as the luminance characteristics. Peak values detected in luminance histograms of the respective regions can be also used as the luminance characteristics. The luminance characteristic acquisition unit 201 outputs the luminance characteristics of the input frame to the luminance calculation unit 202.

Based on the luminance characteristics of the respective regions of the input frame acquired from the luminance characteristic acquisition unit 201, the luminance calculation unit 202 calculates luminance values L1 individually for the plurality of regions of the light emitting unit 300. The luminance value L1 represents an amount of light emission of the light emitting unit 300 used to display an image based on the input frame.

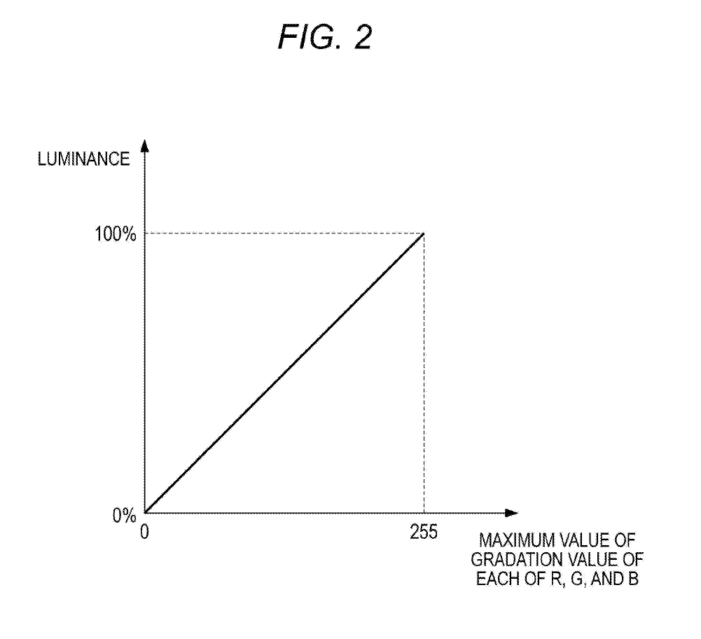

FIG. 2 illustrates a lookup table used for conversion between the luminance characteristic and the luminance value. A horizontal axis denotes the maximum gradation value of each of the regions, whereas a vertical axis denotes the luminance value. In a case where the light source formed by the three colors of red, green, and blue is used, the lookup table is referred to in regard to the largest gradation value among the maximum gradation values of the respective colors, whereby the luminance values L1 of the respective regions are calculated. The luminance values L1 may be calculated from the luminance characteristics using a mathematical formula. The luminance values L1 are output to the luminance estimation unit 203.

The luminance estimation unit 203 estimates a distribution of light radiated to the display unit 400 from the light emitting unit 300 based on the luminance values L1 and distribution coefficients of the respective regions of the light emitting unit 300 acquired in advance. The distribution coefficient is estimated as follows. When one of the regions of the light emitting unit 300 is lighted alone, the lighting region irradiates, with light, not only a region of the display unit 400 corresponding to the lighting region but also regions of the display unit 400 corresponding to regions around the lighting region. By measuring the luminance in advance at estimation points of the display unit 400 corresponding to the center points of the respective regions of the light emitting unit 300 while one region is lighting, the distribution coefficients for the luminance relative to the lighting region are obtained. The distribution coefficients obtained for the respective regions of the light emitting unit 300 are temporarily stored to a memory.

Luminance estimation values PL1 with which the display unit 400 is irradiated when the light emitting unit 300 is lighted with the luminance values L1 are estimated using the luminance values L1 determined by the luminance calculation unit 202 and the aforementioned distribution coefficients. The luminance estimation values PL1 are output to the light emission amount determination unit 206.

The luminance characteristic acquisition unit 204 acquires the luminance characteristics of the high-frequency emphasized subframe. The luminance characteristic acquisition unit 204 acquires the image signal of the high-frequency emphasized subframe output from the high-pass filter 103. The luminance characteristic acquisition unit 204 acquires the luminance characteristics from the acquired image signal of the high-frequency emphasized subframe as in the luminance characteristic acquisition unit 201 to output to the luminance calculation unit 205.

The luminance calculation unit 205 acquires the luminance characteristics of the high-frequency emphasized subframe from the luminance characteristic acquisition unit 204. As in the luminance calculation unit 202, the luminance calculation unit 205 calculates luminance values L2 for the plurality of regions of the light emitting unit 300 based on the luminance characteristics of the respective regions of the high-frequency emphasized subframe. The luminance value L2 represents an amount of light emission of the light emitting unit 300 used to display an image based on the high-frequency emphasized subframe. The luminance values L2 are output to the light emission amount determination unit 206.

The light emission amount determination unit 206 compares the luminance estimation values PL1 and the luminance values L2 to determine the luminance setting values SL1. The light emission amount determination unit 206 compares the luminance estimation value PL1 and the luminance value L2 for each of the regions of the light emitting unit 300 to identify a region whose luminance estimation value PL1 is smaller than the luminance value L2 thereof. In other words, the light emission amount determination unit 206 determines whether the luminance becomes insufficient when the light emitting unit 300 is lighted with the luminance values L1 based on the image signal of the input frame while the high-frequency emphasized subframe is being displayed, to identify a region for which correction is necessary.

Based on the luminance estimation value PL1 and the luminance value L2 of the region determined that correction is necessary therefor, the light emission amount determination unit 206 determines a correction value to determine the luminance setting value SL1 for the light emitting unit 300 by adding the correction value to the luminance value L1. The luminance setting value SL1 is output to the luminance estimation unit 207 and the light emission amount controller 209.

Based on the luminance setting value SL1 acquired from the light emission amount determination unit 206, the light emission amount controller 209 controls the amount of the light radiated from the light emitting unit 300 during a display period of each of the subframes generated from the input frame on the display unit 400. The light emission amount controller 209 may control the amount of light emission of the light emitting unit 300 through pulse width modulation (PWM) carried out on the light emitting unit 300. In this case, the luminance setting value SL1 is expressed by a duty ratio of the pulse width modulation (a ratio between a lighting period and a non-lighting period).

In addition, the light emission amount controller 209 may set a drive voltage value or a drive electric current value for the light emitting unit 300 to control the amount of light emission of the light emitting unit 300. In this case, the luminance setting value SL1 is expressed by the drive voltage value or the drive electric current value. The light emission amount controller 209 may carry out the pulse width modulation on the light emitting unit 300 and also set the drive voltage value or the drive electric current value for the light emitting unit 300 to control the amount of light emission of the light emitting unit 300. In this case, the luminance setting value SL1 is expressed by the duty ratio of the pulse width modulation (a ratio between a lighting period and a non-lighting period) along with the drive voltage value or the drive electric current value.

The luminance estimation unit 207 uses the luminance setting values SL1 to estimate the distributions of the light radiated to the display unit 400 from the light emitting unit 300. A method for estimating the distribution is similar to the case of the luminance estimation unit 203, that is, the luminance setting value SL1 and the distribution coefficient saved in a memory are used for estimation. Luminance estimation values PL2 estimated by the luminance estimation unit 207 are output to the signal correction unit 208.

The signal correction unit 208 obtains a correction coefficient of the image signal for each of the subframes based on the luminance estimation values PL2 to correct the image signal of the subframe. The correction coefficient functions as a coefficient for decompressing the signal to compensate display luminance when the luminance of the light emitting unit 300 is reduced, while being a coefficient obtained to reduce the luminance of the light emitting unit 300 when the luminance thereof is raised. Assuming that estimated luminance at a certain point is Lpn, luminance serving as a target of the decompression/adjustment using the correction coefficient is Lt, and the correction coefficient of the object point is Gpn, the correction coefficient Gpn can be obtained using Gpn=Lt/Lpn. The luminance Lt serving as a target is determined based on peak luminance of a screen.

The signal correction unit 208 multiplies the determined correction coefficient by the corresponding image signal of each of the subframes to correct the image signal of each of the subframes. Because the estimation is based on pixels not adjacent to each other, the correction coefficient of a pixel between one estimated point and another estimated point is obtained based on the correction coefficient values of the periphery thereof through interpolation calculation such that the obtained result is multiplied by that pixel. Additionally, in a case where the result of the multiplication of the correction coefficient exceeds an input range of the display unit 400, the value is corrected such that the result falls within the input range. Subsequently, the signal correction unit 208 alternately outputs the corrected high-frequency emphasized subframe and the corrected high-frequency suppressed subframe in sequence.

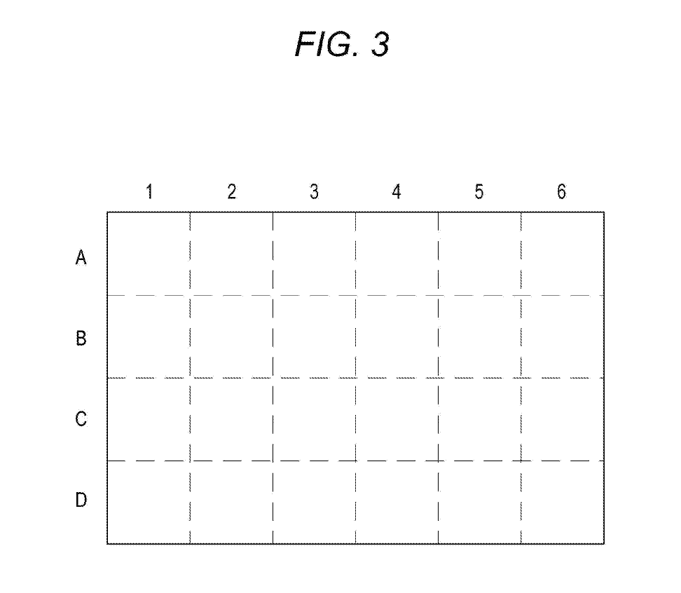

The light emitting unit 300 irradiates the display unit 400 with light based on the control by the light emission amount controller 209. The light emitting unit 300 irradiates with light based on the common luminance setting value SL1 for the high-frequency emphasized subframe and the high-frequency suppressed subframe that have been generated from the same input frame. The light emitting unit 300 is capable of controlling the luminance of each of the plurality of regions. FIG. 3 is a schematic diagram illustrating control regions in the light emitting unit 300 according to the embodiment. In the embodiment, the light emitting unit 300 can separately control the amounts of light emission of 24 regions in total constituted by six sections (1, 2, 3, 4, 5, and 6) divided in the horizontal direction and four sections (A, B, C, and D) divided in a vertical direction.

The display unit 400 is a transmission type display panel such as a liquid crystal panel and controlled based on the image signal of each of the corrected subframes output from the signal correction unit 208 to display an image.

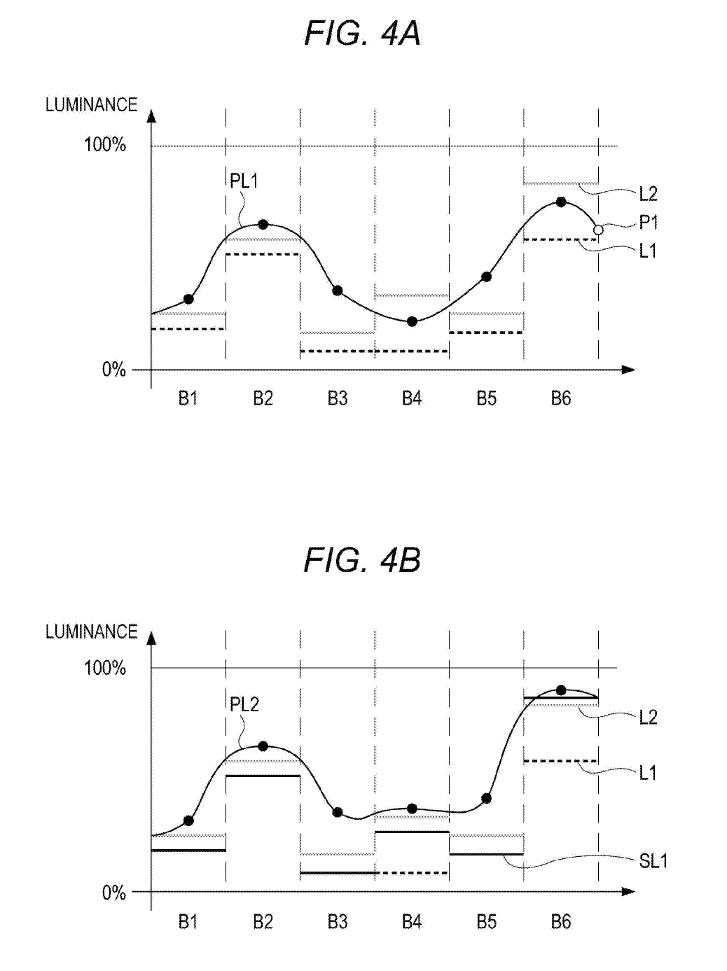

A method for determining the luminance setting values SL1 of the respective regions will be described with reference to FIGS. 4A and 4B. FIG. 4A is a schematic diagram illustrating the luminance values L1, the luminance estimation values PL1, and the luminance values L2 of a region B1 to a region B6. A horizontal axis denotes the respective regions from the region B1 to the region B6, whereas a vertical axis denotes the luminance values. In a case where the respective regions of the light emitting unit 300 are equally driven with the same luminance value, the maximum luminance value is expressed by 100% of the luminance value.

The luminance values L1 are luminance values calculated by the luminance calculation unit 202 based on the luminance characteristics of the input frame acquired by the luminance characteristic acquisition unit 201. Meanwhile, the luminance values L2 are luminance values calculated by the luminance calculation unit 205 based on the luminance characteristics of the high-frequency emphasized subframe acquired by the luminance characteristic acquisition unit 204. The luminance estimation values PL1 are values estimated by the luminance estimation unit 203 based on the luminance values L1 and the distribution coefficients.

The light emission amount determination unit 206 compares the luminance estimation values PL1 and the luminance values L2 for the respective regions. In the regions B1, B2, B3, and B5, the luminance estimation values PL1 are larger than the luminance values L2. On the other hand, in the regions B4 and B6, the luminance estimation values PL1 are smaller than the luminance values L2. In other words, when the light emitting unit 300 is lighted using the luminance values L1 to display an image of the high-frequency emphasized subframe, the luminance becomes insufficient in the regions B4 and B6. Accordingly, the light emission amount determination unit 206 identifies the regions B4 and B6 as regions for which the correction is necessary.

The method for determining the luminance setting value SL1 for the region B6 will be described. Assuming that the luminance value L1 of the region B6 is 70%, the luminance value L2 thereof is 90%, and a minimum value of the luminance estimation value PL1 thereof is 75% as indicated by a point P1, in order for the luminance to satisfy the luminance value L2, the luminance value L1 is to be multiplied by 90%/75%=1.2 times. Accordingly, the correction value of the region B6 is obtained as (70%×1.2)−70%=14%.

Meanwhile, the region B5 and the like adjacent to the region B6 are not identified as the regions for which the correction is necessary and thus the correction values are not added to the luminance values L1. Because leakage light entering to the region B6 from the region B5 and the like does not increase, the correction value obtained based on a difference between the luminance estimation value PL1 of the region B6 including the leakage light and the luminance value L2 has a possibility of resulting in insufficient luminance.

Therefore, it is also possible to add a predetermined offset value in addition to the correction value of the region B6, specifically, 14%. In the embodiment, the correction value of the region B6 has been set to 24% by adding 10%. The predetermined offset value may be another value such as 5% or the like. In addition, the predetermined offset value can be determined based on the size of the region of the light emitting unit 300 or the like.

This added amount can be determined depending on the luminance values L1 of the regions in the periphery of the region for which the correction is necessary. When the luminance values L1 of the regions in the periphery are large, the added amount may be reduced, while the added amount may be increased when the luminance values L1 of the regions in the periphery are small. In addition, a correction value of a similar level to the correction value of the region for which the correction is necessary can be added in the region adjacent to the region for which the correction is necessary.

Specifically, the correction value of 14% to be added in the region B6 can be added to the luminance value L1 of the region B5 adjacent to the region B6 for which the correction is necessary. In addition, a largest correction value among the plurality of regions for which the correction is necessary can be added in all regions. As a result, the luminance setting value SL1 capable of satisfying the luminance value L2 by considering the influence of the leakage light can be obtained for the region for which the correction is necessary.

FIG. 4B is a schematic diagram illustrating the luminance values L1, the luminance values L2, the luminance setting values SL1, and the luminance estimation values PL2 in a luminance distribution of the light radiated to the display unit 400 from the light emitting unit 300 controlled based on the luminance setting values SL1. The luminance setting value SL1 is a value obtained by the light emission amount determination unit 206 adding the correction value to the luminance value L1.

In the embodiment, the correction value of 24% has been added to the luminance value L1 of the region B6. Likewise, the correction value has been obtained and added in the region B4 determined as the region for which the correction is necessary. The luminance value L1 to which the correction value has been added is determined as the luminance setting value SL1 by the light emission amount determination unit 206. The luminance setting value SL1 is output to the luminance estimation unit 207 and the light emitting unit 300. The luminance estimation value PL2 is equal to or larger than the luminance value L2 in every region.

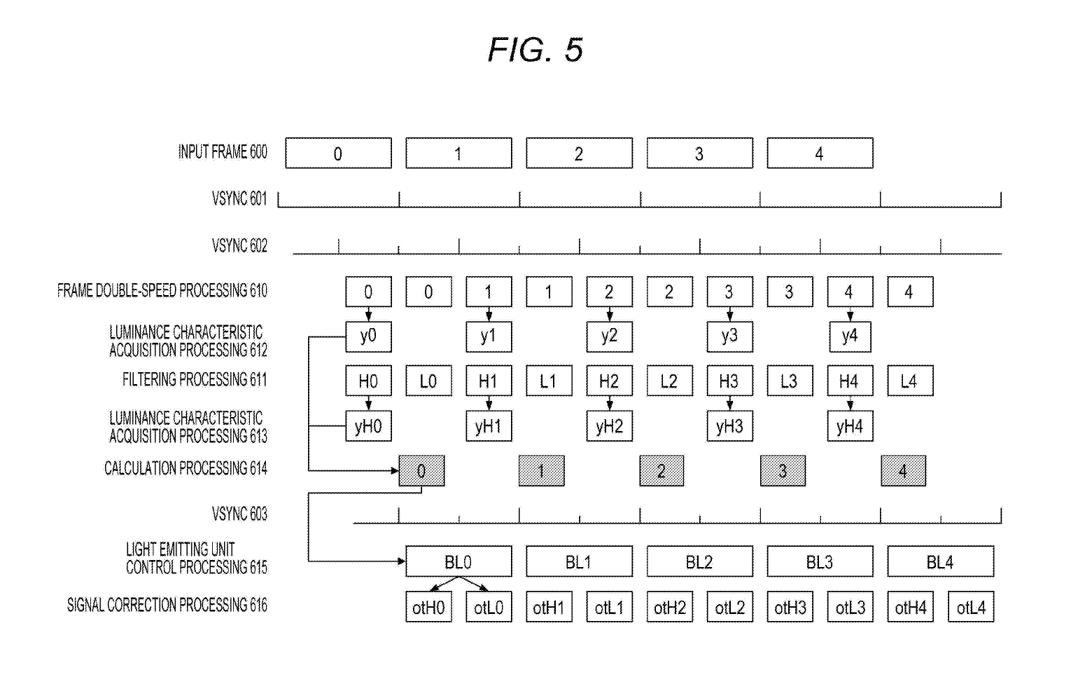

FIG. 5 is a timing diagram illustrating a timing of each processing until the luminance setting value SL1 is determined according to the embodiment. Timings for carrying out processing and outputting the corrected image and a timing for applying to a backlight unit in response to the frame that has been input will be described with reference to FIG. 5. A VSYNC 601 is a synchronization signal representing a vertical period of the frame. An input frame 600 is input to the frame double-speed processor 101 in synchronization with this VSYNC 601. Numbers noted on the respective input frames 600 refer to an order of the frames to be input.

In frame double-speed processing 610, the frame double-speed processor 101 outputs the input frame 600 at a subframe frequency twice a frame frequency. A double-speed subframe is output from the frame double-speed processor 101 in synchronization with a VSYNC 602 delayed by a half period of the input frame frequency relative to the VSYNC 601. Numbers noted on the subframes correspond to the numbers of the input frames, indicating that the image signal of the frame with the same number is output twice as the subframes.

In filtering processing 611, a high-frequency suppressed subframe L and a high-frequency emphasized subframe H are generated using the subframes output during the frame double-speed processing 610 and these subframes are output alternately. The low-pass filter 102 passes the low-frequency components in the subframe output during the frame double-speed processing 610 to generate the high-frequency suppressed subframe. Meanwhile, the high-pass filter 103 passes the high-frequency components in the subframe output during the frame double-speed processing 610 to generate the high-frequency emphasized subframe.

The respective subframes having passed the respective filters are subjected to switching processing in the frame switching unit 104 to be output alternately. Numbers added next to H and L indicate that the filtering processing has been carried out on the subframes with the same numbers.

In luminance characteristic acquisition processing 612, the luminance characteristic acquisition unit 201 acquires the luminance characteristics of the input frame at a timing at which the frame double-speed processor 101 outputs the subframe. In luminance characteristic acquisition processing 613, the luminance characteristic acquisition unit 204 acquires the luminance characteristics of the high-frequency emphasized subframe at an output timing of the high-frequency emphasized subframe from the high-pass filter 103.

In calculation processing 614, the luminance setting value SL1 is determined through the calculation using the luminance characteristics of the input frame and the luminance characteristics of the high-frequency emphasized subframe that have been acquired to be output to the light emission amount controller 209. Details of the calculation processing are similar to the processing that has been described with reference to FIGS. 4A, 4B, and the like.

In light emitting unit control processing 615, the light emitting unit 300 is caused to emit light using the luminance setting value SL1. A VSYNC 603 is a synchronization signal for outputting the respective subframes. A control signal base on the luminance setting value SL1 is output to the light emitting unit 300 in synchronization with the VSYNC 603, whereby the light emitting unit 300 irradiates the display unit 400 with light.

Numbers next to BLs noted on the respective frames in the light emitting unit control processing 615 indicate that the luminance setting values SL1 have been calculated from the input frames of the corresponding numbers. Specifically, during a period for which the high-frequency emphasized subframe and the high-frequency suppressed subframe generated from the same input frame are displayed on the display unit 400, the light emitting unit 300 emits light based on the luminance setting value SL1 calculated from that input frame.

In signal correction processing 616, the signal correction unit 208 calculates the correction value based on the luminance estimation value PL2 estimated from the luminance setting value SL1 and the distribution coefficient to correct each of the subframes. Numbers following BLs in the respective subframes in the signal correction processing 616 corresponds to the subframe numbers, indicating that the correction processing has been carried out on the subframes of the corresponding numbers.

In the embodiment, the control signal outputting and the signal correction have been carried out for the light emitting unit 300 at proper timings in response to the input frame. In order to achieve this, however, the frame using the frame memory or the like is delayed. In a case where the reduction of the cost for the frame memory is required, such processing may be applied by being shifted in units of the frequencies of the input frame. For example, results of the calculation for a frame 0 (the control signal for the light emitting unit and the signal correction) may be applied to a frame 1. Note that, however, the subframes are not shifted during the application. Accordingly, results of the calculation for one input frame are applied to the high-frequency emphasized subframe and the high-frequency suppressed subframe as a pair.

As described thus far, according to the embodiment, the luminance of the light emitting unit can be favorably controlled when the high-frequency emphasized subframe in which the high-frequency components are emphasized and the high-frequency suppressed subframe in which the high-frequency components are suppressed are alternately displayed.

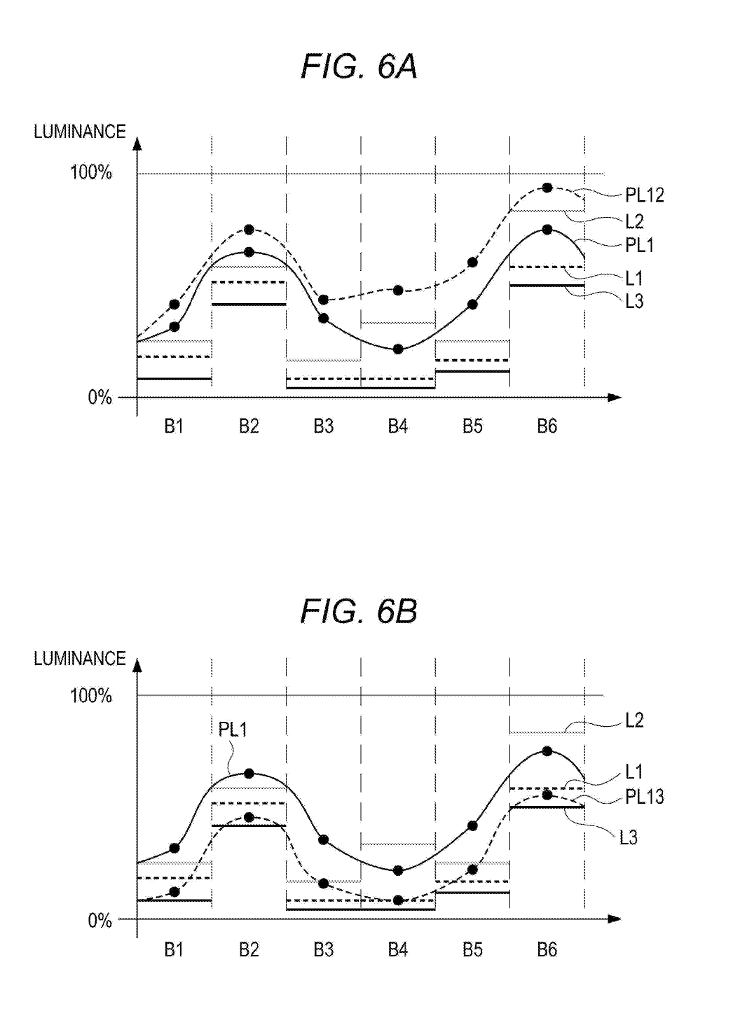

In the embodiment, the luminance setting value SL1 has been determined by adding the correction value to the luminance value L1 for a region whose luminance estimation value PL1 is smaller than the luminance value L2 thereof. However, it is also possible to apply the luminance value L1 calculated based on the luminance characteristics of the input frame to all regions. FIGS. 6A and 6B are schematic diagrams illustrating the luminance values and the luminance estimation values of the respective regions. FIG. 6A is a diagram illustrating the luminance values L1, the luminance estimation values PL1, the luminance values L2, luminance estimation values PL12 estimated based on the luminance values L2, and luminance values L3 described later.

In one embodiment, the luminance of the light emitting unit 300 be reduced in the regions B3 and B5 since the luminance characteristics of the input frame and the respective subframes are low therein. However, when the luminance values L2 are used as the luminance setting values SL1 in all regions, the luminance is unnecessarily made higher as indicated by the luminance estimation values PL12.

Meanwhile, FIG. 6B is a diagram illustrating the luminance values L1, the luminance estimation values PL1, the luminance values L2, the luminance values L3 calculated based on the luminance characteristics acquired from the high-frequency suppressed subframe, and luminance estimation values PL13 estimated based on the luminance values L3. In the regions B4 and B6, the luminance characteristics of the high-frequency emphasized subframe are high but when the luminance setting values SL1 are used as the luminance values L2 in all regions, the luminance becomes insufficient as indicated by the luminance estimation values PL13.

Accordingly, by applying the luminance values L1 calculated based on the luminance characteristics of the input frame as the luminance setting values SL1, the favorable luminance can be obtained.

The embodiment has described a case where the input frame is subjected to the double-speed processing such that two subframes are generated. However, N-time-speed processing (N>2) is also possible. In this case, the plurality of high-frequency emphasized subframes and the plurality of high-frequency suppressed subframes may be generated by carrying out one of the high-frequency emphasis processing and the high-frequency suppression processing on the plurality of subframes individually. In addition, part of the subframes may be output as subframes having image signals similar to that of the input frame. Furthermore, in this case, the respective subframes can be displayed by being switched therebetween within a display period of the input frame.

When the subframe equivalent to the input frame or the high-frequency suppressed subframe is displayed after the high-frequency emphasized subframe, the motion blur can be suppressed. In addition, the amount of light emission of the light emitting unit 300 within the display period of the input frame can be controlled using the method described in the embodiment.

### Second Embodiment

In the first embodiment, the correction value has been obtained from a difference between the luminance estimation value PL1 based on the luminance value L1 and the luminance value L2 to be add to the luminance value L1, thereby obtaining the luminance setting value. In a second embodiment, a luminance estimation value PL1 based on a luminance value L1 and a luminance value L2 are compared and the luminance value L2 is used as a luminance setting value SL2 in the region for which the correction is necessary.

The second embodiment will be described with reference to the functional block diagram in FIG. 1. The description of blocks functioning similarly to those of the first embodiment will be omitted. A light emission amount determination unit 206 acquires the luminance value L1, the luminance value L2, and the luminance estimation value PL1. The light emission amount determination unit 206 determines the region for which the correction is necessary based on the luminance estimation value and the luminance value L2. A method for determining the region for which the correction is necessary is similar to that of the first embodiment.

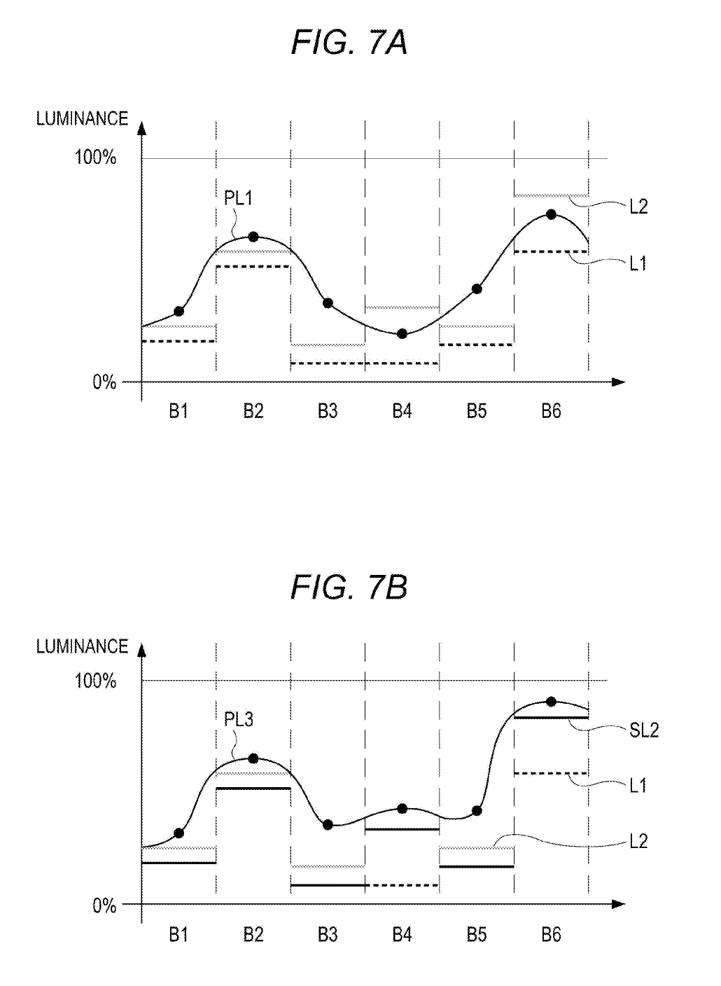

The light emission amount determination unit 206 determines the luminance value L2 as the luminance setting value SL2 for the region determined that the correction is necessary therefor, while determining the luminance value L1 as the luminance setting value SL2 for the other regions. Specifically, a method for determining the luminance setting value SL2 will be described with reference to FIGS. 7A and 7B.

FIG. 7A is a schematic diagram illustrating the luminance values L1, the luminance values L2, and the luminance estimation values PL1 of a region B1 to a region B6. A horizontal axis denotes the respective regions from the region B1 to the region B6, whereas a vertical axis denotes the luminance values.

The luminance values L1 are luminance values calculated by a luminance calculation unit 202 based on the luminance characteristics of the input frame acquired by a luminance characteristic acquisition unit 201. Meanwhile, the luminance values L2 are luminance values calculated by a luminance calculation unit 205 based on the luminance characteristics of the high-frequency emphasized subframe acquired by a luminance characteristic acquisition unit 204. The luminance estimation values PL1 are values estimated by a luminance estimation unit 203 based on the luminance values L1 and the distribution coefficients.

The light emission amount determination unit 206 uses these luminance values and luminance estimation values to determine the luminance setting value SL2. The light emission amount determination unit 206 compares the luminance estimation values PL1 and the luminance values L2 for the respective regions. In the regions B1, B2, B3, and B5, the luminance estimation values PL1 are larger than the luminance values L2. On the other hand, in the regions B4 and B6, the luminance estimation values PL1 are smaller than the luminance values L2. Accordingly, the light emission amount determination unit 206 identifies the regions B4 and B6 as the regions for which the correction is necessary.

The light emission amount determination unit 206 determines the luminance values L2 as the luminance setting values SL2 for the regions B4 and B6 for which the correction is necessary. Meanwhile, the light emission amount determination unit 206 determines the luminance values L1 as the luminance setting values SL2 for the other regions. Accordingly, as illustrated in FIG. 7B, the luminance values L1 and the luminance values L2 are mixed in the luminance setting values SL2. At this time, in a luminance distribution PL3 of the light radiated to a display unit 400 from a light emitting unit 300 based on the luminance setting values SL2, the regions B4 and B6 have the luminance equal to or higher than the luminance values L2.

According to the configuration of the embodiment, an image is displayed using the high-frequency emphasized subframe in which the high-frequency components are emphasized and the high-frequency suppressed subframe in which the high-frequency components are suppressed, whereby the motion blur can be suppressed and also the luminance can be properly set in accordance with the luminance characteristics of the high-frequency emphasized subframe. Additionally, because the calculation and the addition of the correction value are omitted compared to the first embodiment, the amount of calculation can be reduced.

As described thus far, the embodiments according to the invention have been described using, as an example, the display device that displays an image on the display panel using a transmission type display panel such as a liquid crystal panel. However, the display device of the invention is not limited thereto. The invention can be also applied to, for example, a projector in which light radiated from the light emitting unit 300 passes through the display unit 400 such that an image is projected on a screen installed in front of the display unit 400.

Furthermore, the functions of the respective functional blocks described above can be realized using an electric circuit. Alternatively, the functional blocks can be implemented in a CPU as a program for realizing the respective functions thereof. In addition, the light emission amount controller 209 may be built within the light emitting unit 300.

### Third Embodiment

In the first embodiment and the second embodiment, the light emitting unit has been controlled based on a value obtained by correcting the luminance value L1 based on a difference between the luminance estimation value PL1 based on the luminance value L1 obtained from the luminance characteristics of the input frame and the luminance value L2 obtained from the luminance characteristics of the high-frequency emphasized subframe. In a third embodiment, a light emitting unit is controlled using one of the luminance values among a luminance value L3 obtained from the luminance characteristics of the high-frequency suppressed subframe and a luminance value L2.

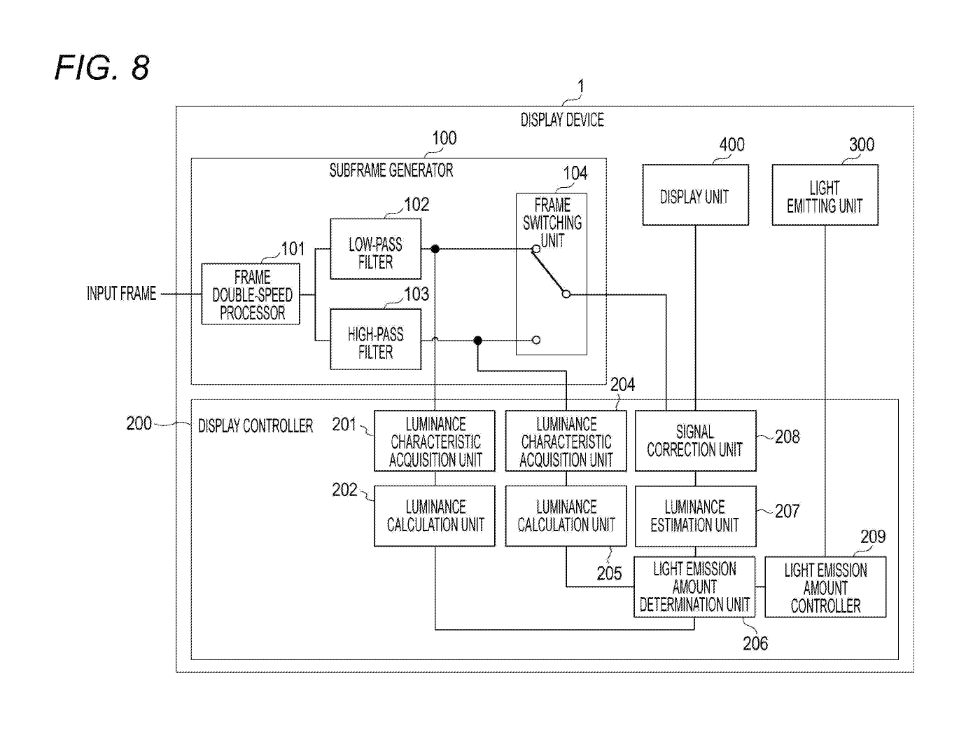

FIG. 8 is a functional block diagram illustrating a display device 1 according to the third embodiment. The display device 1 includes a subframe generator 100, a display controller 200, a light emitting unit 300, and a display unit 400. The subframe generator 100, the light emitting unit 300, and the display unit 400 are functional blocks that realize functions similar to those of the first embodiment and thus the detailed description thereof will be omitted.

The display controller 200 includes a luminance characteristic acquisition unit 201, a luminance calculation unit 202, a luminance characteristic acquisition unit 204, a luminance calculation unit 205, a light emission amount determination unit 206, a luminance estimation unit 207, a signal correction unit 208, and a light emission amount controller 209. The luminance characteristic acquisition unit 204, the luminance calculation unit 205, the luminance estimation unit 207, and the signal correction unit 208 are functional blocks that realize functions similar to those of the first embodiment and the second embodiment and thus the detailed description thereof will be omitted.

The luminance characteristic acquisition unit 201 acquires the image signal of the high-frequency suppressed subframe output from a low-pass filter 102. The luminance characteristic acquisition unit 201 acquires, from the acquired image signal of the high-frequency suppressed subframe, the luminance characteristics of respective regions corresponding to a plurality of regions of the light emitting unit 300 described later. The luminance characteristic acquisition unit 201 outputs the luminance characteristics of the high-frequency suppressed subframe to the luminance calculation unit 202.

Based on the luminance characteristics of the respective regions of the high-frequency suppressed subframe acquired from the luminance characteristic acquisition unit 201, the luminance calculation unit 202 calculates luminance values L3 individually for the plurality of regions of the light emitting unit 300. The luminance value L3 represents an amount of light emission of the light emitting unit 300 used to display an image based on the high-frequency suppressed subframe.

The luminance calculation unit 202 refers to the lookup table illustrated in FIG. 2 to calculate the luminance values L3 of the respective regions. The luminance values may be calculated from the luminance characteristics using a mathematical formula. The luminance values L3 are output to the light emission amount determination unit 206.

The light emission amount determination unit 206 compares the luminance value L3 and the luminance value L2 with a threshold Z0 to determine a luminance setting value SL3. The light emission amount determination unit 206 determines one of the luminance value L3 and the luminance value L2 as a luminance setting value SL3 for each of the regions. The luminance setting value SL3 is output to the luminance estimation unit 207 and the light emission amount controller 209.

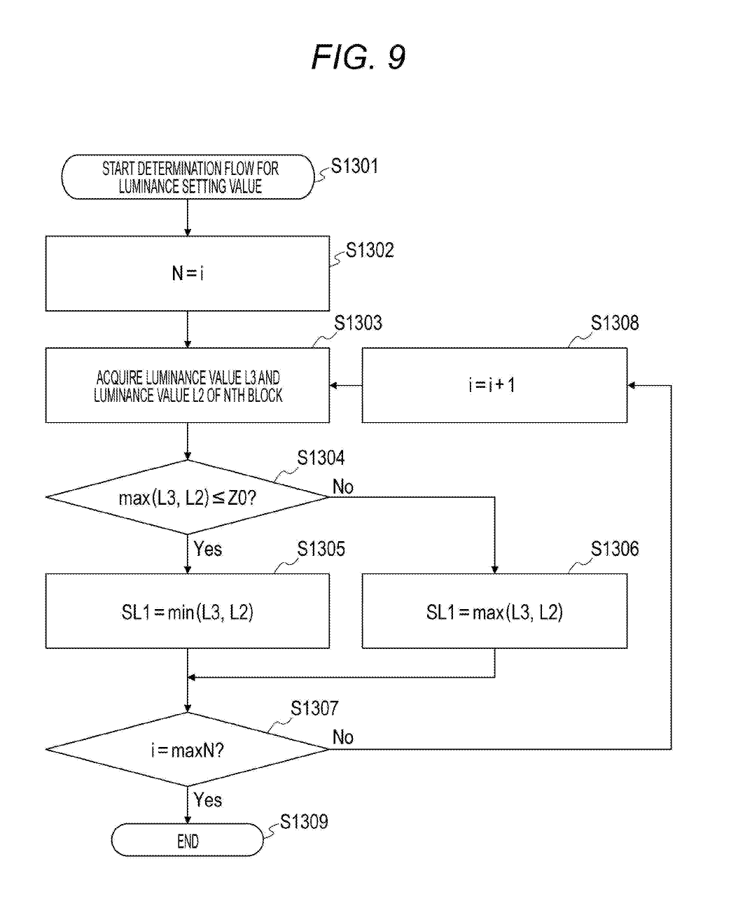

Based on the luminance setting value SL3 acquired from the light emission amount determination unit 206, the light emission amount controller 209 controls the amount of the light radiated from the light emitting unit 300 during a display period of each of the subframes generated from the input frame on the display unit 400. FIG. 9 is a flowchart illustrating a determination flow for the luminance setting value in the light emission amount determination unit 206. The determination flow for the luminance setting value in the light emission amount determination unit 206 is started in step S1301. In step S1302, N=ith region among the plurality of regions of the light emitting unit 300 is assumed to be subjected to determination processing. i starts with one and the processing is sequentially carried out starting from a first block. In step S1303, the light emission amount determination unit 206 acquires the luminance value L3 and the luminance value L2 of Nth region from among the luminance values L3 and the luminance values L2 acquired from the luminance calculation unit 202 and the luminance calculation unit 205, respectively.

Step S1304 determines whether the largest value among the luminance value L3 and the luminance value L2 is equal to or smaller than the threshold Z0. When the determination result is Yes, the smallest value among the luminance value L3 and the luminance value L2 is determined as the luminance setting value SL3 of the Nth region in step S1305. Meanwhile, when the determination in step S1304 is No, the largest value among the luminance value L3 and the luminance value L2 is determined as the luminance setting value SL3 of the Nth region in step S1306.

Here, the threshold Z0 is determined depending on a setting value of display contrast of the display device 1. When a dark image with low gradation is displayed, black brightening occurs with ease, where part of the light radiated from the light emitting unit 300 unintentionally passes through the display unit 400. In order to suppress the black brightening, reducing the amount of light emission of the light emitting unit 300 is effective. Because the small luminance value is more likely to be determined as the luminance setting value SL3 as the threshold Z0 becomes larger, the threshold Z0 is set to a larger value as the setting value of the display contrast of the display device 1 becomes larger. In addition, when a setting value of the maximum display luminance of the display device 1 is changed, the threshold Z0 is set to a larger value in accordance with an increase in the setting value of the maximum display luminance.

The threshold Z0 can be arbitrarily set depending on a preference of a user. For example, the threshold ZO can be set to a smaller value in accordance with the maximum value of the display luminance. In the light emitting unit 300 capable of controlling the luminance setting values SL3 of the multiple regions, there is a case where the light radiated from a region with a large luminance setting value SL3 is diffused toward an adjacent region with a small luminance setting value SL3 and thereby irradiates the display unit 400 corresponding to that region. As a result, the display unit 400 corresponding to the region with a small luminance setting value SL3 is irradiated with light with luminance equal to or higher than necessary luminance and consequently an effect called a halo phenomenon is caused on an image. The halo phenomenon more prominently appears when a difference in the luminance setting values between the adjacent regions is larger. Additionally, the halo phenomenon occurs more easily when the maximum value of the display luminance is larger.

Images corresponding to regions with a large luminance value L3 and a large luminance value L2 are bright images with high gradation; therefore, in one embodiment, a larger luminance value be determined as the luminance setting value SL3. At this time, in order to suppress the halo phenomenon, the luminance setting value SL3 be made larger for a region with larger respective luminance values and also the luminance setting value SL3 be made larger for a region adjacent to that region, which corresponds to an image with low gradation.

When the threshold Z0 is set to a smaller value, larger values among the luminance values L3 and the luminance values L2 are more likely to be determined as the luminance setting values SL3 for a region corresponding to a bright image with high gradation and a region adjacent to that region. At the same time, the halo phenomenon more remarkably appears as the setting value of the maximum display luminance becomes larger. Accordingly, a ratio of the threshold Z0 to the amount of light emission that can be set in the light emitting unit 300 is made smaller as the setting value of the maximum display luminance becomes larger. As a result, a difference in the luminance setting values SL3 between the adjacent regions is made smaller, whereby the halo phenomenon can be suppressed.

Step S1307 determines whether N=i that has been processed is equal to the number of regions (maxN). When the determination result is No, one is added to i in step S1308 and the processing returns to step S1303 again to continue. When the determination result is Yes, the determination flow is terminated (S1309).

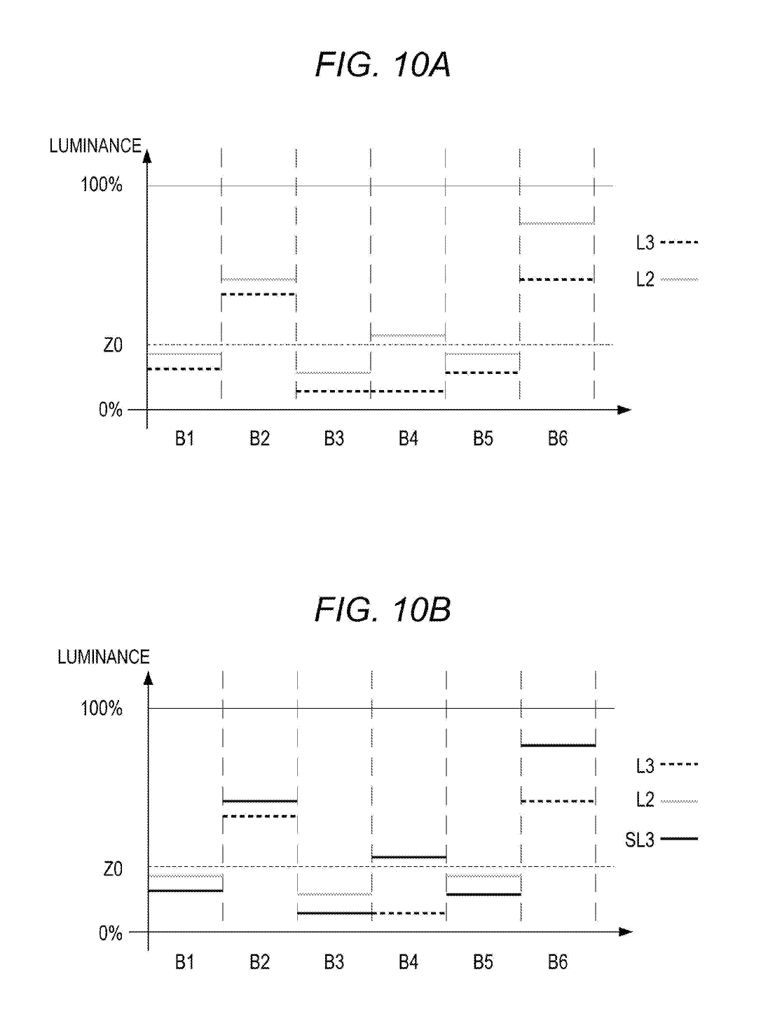

A method for determining the luminance setting value SL3 will be described with reference to FIGS. 10A and 10B. Hereinafter, the method for determining the luminance setting value SL3 will be described for the regions in the horizontal direction from the region B1 to the region B6 illustrated in FIG. 3. However, the luminance setting value SL3 can be similarly determined for other regions.

FIG. 10A is a diagram illustrating the luminance values L3 and the luminance values L2 of the region B1 to the region B6. A horizontal axis denotes the respective regions from the region B1 to the region B6, whereas a vertical axis denotes the luminance values. The luminance values L3 are luminance values calculated by the luminance calculation unit 202 based on the luminance characteristics of the high-frequency suppressed subframe acquired by the luminance characteristic acquisition unit 201. Meanwhile, the luminance values L2 are luminance values calculated by the luminance calculation unit 205 based on the luminance characteristics of the high-frequency emphasized subframe acquired by the luminance characteristic acquisition unit 204.

The light emission amount determination unit 206 compares the luminance values L3 and the luminance values L2 with the threshold Z0 read from a memory for the respective regions. In each of the regions B1, B3, and B5, the maximum value among the luminance value L3 and the luminance value L2 is smaller than the threshold Z0. In other words, this means that both of the luminance value L3 and the luminance value L2 are smaller than the threshold Z0. On the other hand, in each of the regions B2, B4, and B6, the maximum value among the luminance value L3 and the luminance value L2 is larger than the threshold Z0. In other words, this means that one of the luminance value L3 and the luminance value L2 or both thereof are larger than the threshold Z0.

FIG. 10B illustrates the luminance setting values SL3 determined by the light emission amount determination unit 206 in addition to the luminance values L3 and the luminance values L2 of the region B1 to the region B6. In the regions B1, B3, and B5, each of which has been determined that the maximum value among the luminance value L3 and the luminance value L2 is smaller than the threshold Z0, the luminance values L3 are determined as the luminance setting values SL3. On the other hand, in the regions B2, B4, and B6, each of which has been determined that the maximum value among the luminance value L3 and the luminance value L2 is larger than the threshold Z0, the maximum values among the luminance values L3 and the luminance values L2 are determined as the luminance setting values SL3. In all of these regions, the luminance values L2 are determined as the luminance setting values SL3.

In the embodiment, the threshold Z0 set in advance has been used for the determination. However, the threshold Z0 can be corrected. The luminance value L3 and the luminance value L2 of a region to be determined are compared with the luminance value L3 and the luminance value L2 of a region adjacent to the region to be determined. When a difference between the luminance values of the adjacent regions is larger than a predetermined value, the threshold is made larger.

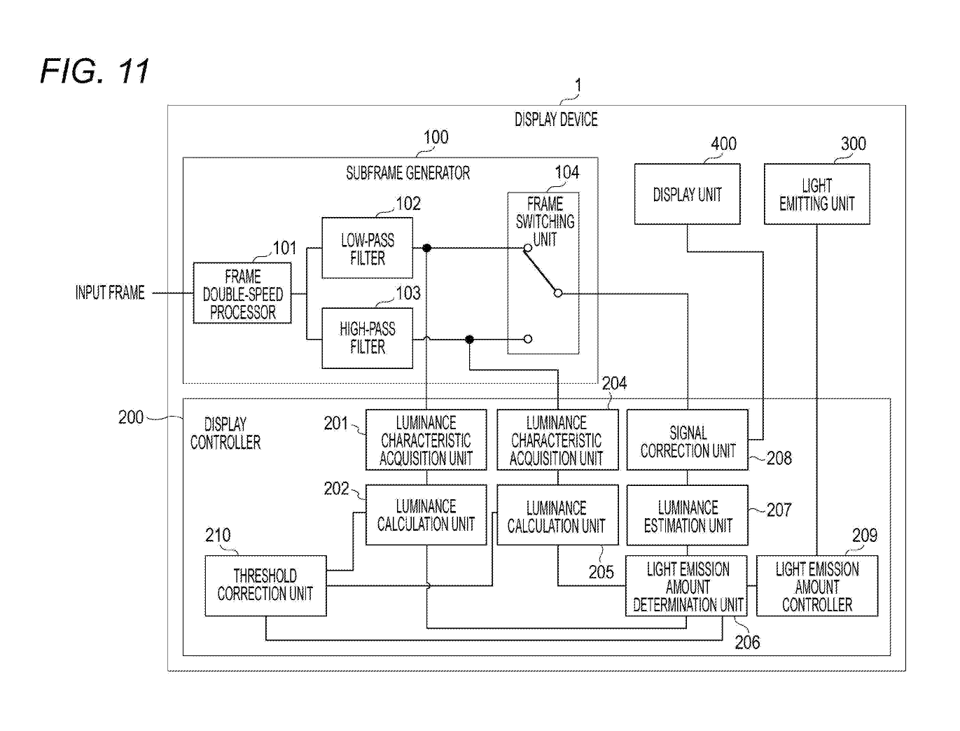

FIG. 11 is a functional block diagram illustrating a display device 1 in which a threshold correction unit 210 is added to the display controller 200. The description of blocks having the same names as those in the functional block diagram in FIG. 8 will be omitted. The threshold correction unit 210 acquires the luminance value L3 and the luminance value L2 from the luminance calculation unit 202 and the luminance calculation unit 205, respectively. The threshold correction unit 210 compares a smaller value among the luminance value L3 and the luminance value L2 of a certain region with a larger value among the luminance value L3 and the luminance value L2 of a region adjacent to that region.

According to FIG. 10A, a difference between the luminance value L3 of the region B5 and the luminance value L2 of the region B6 is large. In this case, the gradation of an image corresponding to the region B5 is low, while the gradation of an image corresponding to the region B6 is high. When a difference in the gradation between the images corresponding to the adjacent regions is large, in one embodiment, the luminance setting value SL3 of the region B5 be set to a smaller value in order to increase the expressivity of the contrast.

When a difference between a smaller value of the luminance of the region B5 and a larger value among the luminance of a region adjacent to the region B5 is larger than a predetermined value, the threshold correction unit 210 increases the threshold Z0 for the region B5. By increasing the threshold Z0, lower luminance is more likely to be determined as the luminance setting value SL3 when the light emission amount determination unit 206 determines the luminance value for the region B5. The luminance setting value SL3 of the region B5 which is made smaller can serve as an optimum luminance value for the image with low gradation corresponding to the region B5.

On the other hand, when a difference between a smaller value among the luminance of the region B5 and a larger value among the luminance of the region adjacent to the region B5 is equal to or smaller than the predetermined value, the threshold correction unit 210 may reduce the threshold Z0 for the region B5. By reducing the threshold Z0, the luminance setting value SL3 of the region B5 is more likely to be determined to a larger value among the luminance value L3 and the luminance value L2. In this case, a difference in the luminance setting values SL3 between the region B5 and the region adjacent thereto is made smaller and accordingly, the aforementioned effect to the display luminance due to the halo phenomenon can be reduced.

The setting of the threshold correction unit 210 can be arbitrarily configured by a user. The threshold correction unit 210 may carry out the aforementioned correction processing in a case where one of the luminance value L3 and the luminance value L2 of a region to be determined exceeds the threshold Z0 before the correction.

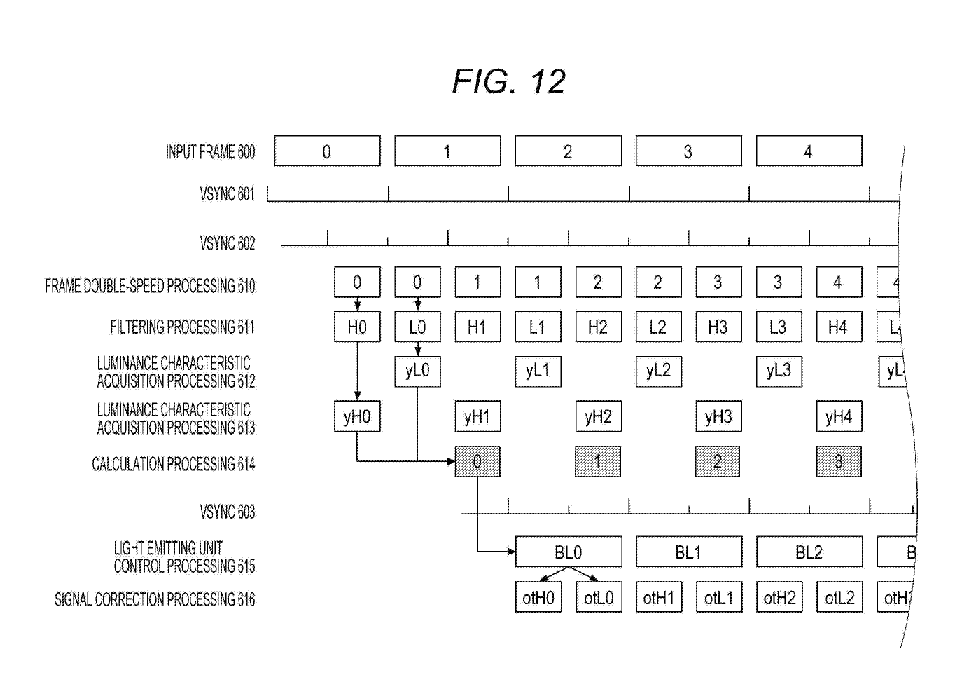

FIG. 12 is a timing diagram illustrating a timing of each processing until the luminance setting value SL3 is determined according to the embodiment. A VSYNC 601, a VSYNC 602, and a VSYNC 603 are synchronization signals similar to those in the first embodiment. Frame double-speed processing 610, filtering processing 611, luminance characteristic acquisition processing 613, and signal correction processing 616 among all of the processing are processing similar to that in the first embodiment and thus the description thereof will be omitted.

In luminance characteristic acquisition processing 612, the luminance characteristic acquisition unit 201 acquires the luminance characteristics at an output timing of the high-frequency suppressed subframe from the low-pass filter 102.

In calculation processing 614, the luminance setting value SL3 is determined through the calculation using the luminance characteristics of the high-frequency suppressed subframe and the luminance characteristics of the high-frequency emphasized subframe that have been acquired to be output to the light emission amount controller 209. Details of the calculation processing are similar to the processing that has been described with reference to FIGS. 10A, 10B, and the like.

In light emitting unit control processing 615, the light emitting unit 300 is caused to emit light using the luminance setting value SL3. During a period for which the respective subframes generated from the same input frame are displayed on the display unit 400, the light emitting unit 300 emits light based on the luminance setting value SL3 calculated from these subframes.

As described thus far, according to the embodiment, the luminance of the light emitting unit can be favorably controlled when the high-frequency emphasized subframe in which the high-frequency components are emphasized and the high-frequency suppressed subframe in which the high-frequency components are suppressed are alternately displayed.

### Fourth Embodiment

In the third embodiment, the amount of light emission has been controlled using the threshold Z0 along with one of the luminance values among the luminance value L3 obtained based on the luminance characteristics of the high-frequency suppressed subframe and the luminance value L2. In a fourth embodiment, the amount of light emission is controlled depending on a relationship between a threshold Z1 and a difference between a luminance value L3 and a luminance value L2.

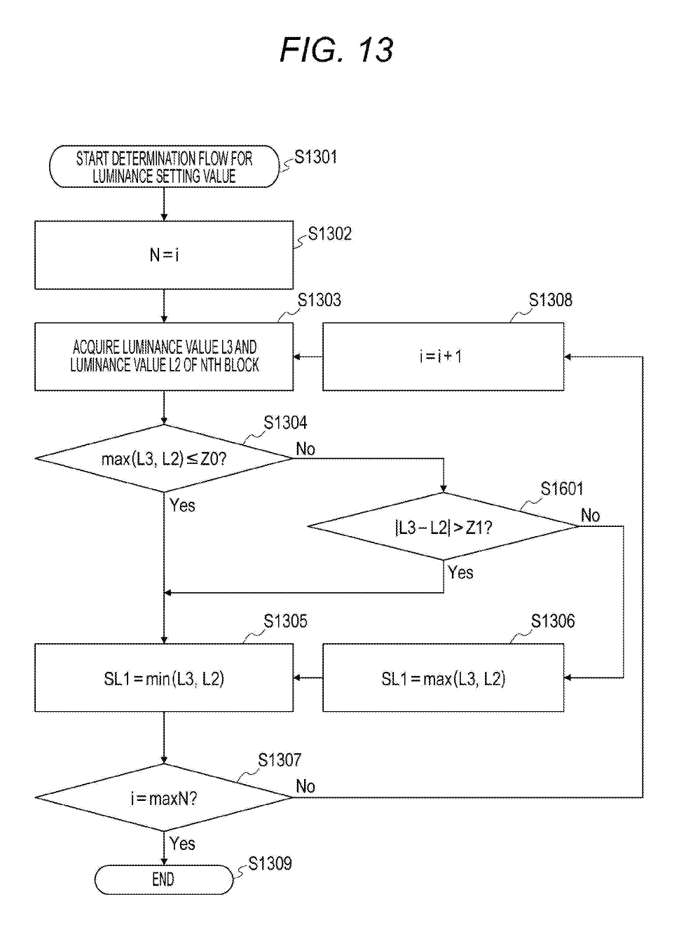

The fourth embodiment will be describe with reference to a flowchart in FIG. 13. Functional blocks and a flow having the same names as those in the third embodiment realize functions and processing similar to those in the third embodiment and thus the description thereof will be omitted. A light emission amount determination unit 206 acquires the luminance value L3 and the luminance value L2. As in the third embodiment, the light emission amount determination unit 206 determines whether each luminance is no more than the threshold Z0 (S1304).

When at least one of the luminance value L3 and the luminance value L2 is equal to or larger than the threshold Z0 (S1304: No), a light emission amount determination unit 206 makes determination on a threshold Z1 and an absolute value of a difference between the luminance value L3 and the luminance value L2 (S1601). When the absolute value of a difference between the luminance value L3 and the luminance value L2 is larger than the threshold Z1, the light emission amount determination unit 206 determines a larger value among the luminance value L3 and the luminance value L2 as a noise component.

When the absolute value of a difference between the luminance value L3 and the luminance value L2 is larger than the threshold Z1, the light emission amount determination unit 206 determines a smaller value among the luminance value L3 and the luminance value L2 as a luminance setting value SL4 (S1601: Yes). On the other hand, when the absolute value of a difference between the luminance value L3 and the luminance value L2 is smaller than the threshold Z1, the light emission amount determination unit 206 determines a larger value among the luminance value L3 and the luminance value L2 as the luminance setting value SL4 (S1601: No).

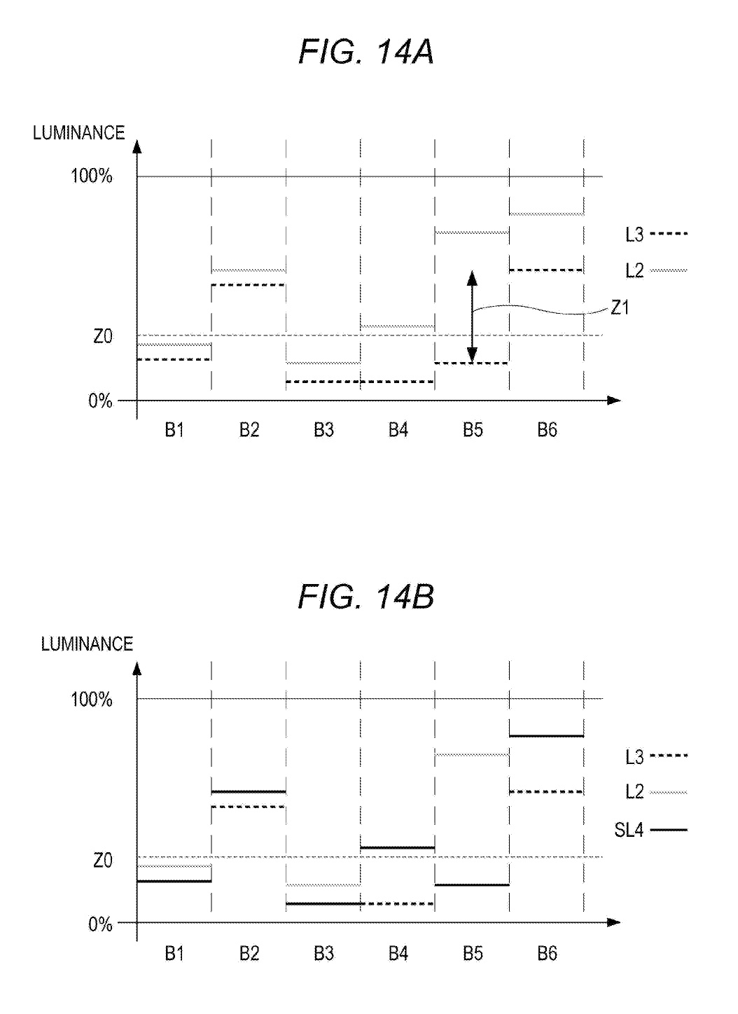

FIG. 14A is a schematic diagram illustrating the luminance values L3 and the luminance values L2 of respective regions from a region B1 to a region B6 acquired by the light emission amount determination unit 206. FIG. 14B is a schematic diagram illustrating the luminance setting values SL4 of the region B1 to the region B6 determined by the light emission amount determination unit 206 based on the luminance values L3 and the luminance values L2 of the respective regions. As illustrated in FIG. 14A, a difference between the luminance value L3 and the luminance value L2 is larger than the threshold Z1 in the region B5. At this time, as illustrated in FIG. 14B, the luminance value L3 is determined as the luminance setting value SL4 for the region B5. Meanwhile, the luminance setting values SL4 are determined using a method similar to that of the third embodiment for the other regions.

According to the embodiment, the luminance of the light emitting unit can be favorably controlled when the high-frequency emphasized subframe in which the high-frequency components are emphasized and the high-frequency suppressed subframe in which the high-frequency components are suppressed are alternately displayed. Furthermore, the light emitting unit is lighted using luminance on a low luminance side in a region with a possibility of having a noise component, whereby a flicker can be suppressed.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2015-102127, filed May 19, 2015, and 2015-102128, filed May 19, 2015, which are hereby incorporated by reference herein in their entirety.

What is claimed is:

1. A display device comprising:
a display unit configured to display an image on a screen based on an input frame;
a light emitting unit including a plurality of light emitting regions whose light emission is separately controllable and configured to irradiate the display unit with light; and
a control unit configured to control the light emission of each of the light emitting regions using luminance determined for each of the light emitting regions using the input frame, wherein
when the display unit displays a first subframe in which high-frequency components of the input frame are emphasized and a second subframe in which the high-frequency components of the input frame are suppressed by switching therebetween, the control unit applies the determined luminance during a period for which the first subframe is displayed and a period for which the second subframe is displayed to control the light emission.

2. The display device according to claim 1, wherein when the display unit displays the first subframe and the second subframe, the control unit uses at least one of a first luminance value based on a luminance characteristic of a region of the first subframe corresponding to each of the light emitting regions and a second luminance value based on a luminance characteristic of a region of the second subframe corresponding to each of the light emitting regions to control the light emission of each of the light emitting regions.

3. The display device according to claim 2, wherein the control unit uses a smaller luminance value among the first luminance value and the second luminance value to control the light emission of the light emitting region in which a difference between the first luminance value and the second luminance value is larger than a first threshold.

4. The display device according to claim 2, wherein the control unit uses a smaller luminance value among the first luminance value and the second luminance value to control the light emission of the light emitting region in which the first luminance value and the second luminance value are smaller than a second threshold.

5. The display device according to claim 4, wherein the control unit uses a larger luminance value among the first luminance value and the second luminance value to control the light emission of the light emitting region in which at least one of the first luminance value and the second luminance value is larger than the second threshold.

6. The display device according to claim 4, wherein the second threshold becomes larger as a setting value of display contrast of the display device becomes larger.

7. The display device according to claim 4, wherein the second threshold becomes larger as a setting value of maximum display luminance of the display device becomes larger.

8. The display device according to claim 4, wherein a ratio between the second threshold and a maximum value of an amount of light emission determinable by the control unit becomes smaller as a setting value of maximum display luminance of the display device becomes larger.

9. The display device according to claim 4, wherein
the control unit includes a threshold correction unit configured to, in a case where a difference between a smaller luminance value among the first luminance value and the second luminance value of a certain light emitting region and a larger luminance value among the first luminance value and the second luminance value of a light emitting region adjacent to the certain light emitting region is larger than a predetermined value, increase the second threshold for the certain light emitting region, and
the control unit controls the light emission of the certain light emitting region based on the second threshold.

10. The display device according to claim 1, wherein when the display unit displays the first subframe and the second subframe, the control unit uses a third luminance value based on a luminance characteristic of a region of the input frame corresponding to each of the light emitting regions to control the light emission of each of the light emitting regions.

11. The display device according to claim 10, further comprising an estimation unit configured to obtain a luminance estimation value of the display unit corresponding to each of the light emitting regions in a case where the display unit is irradiated with light from the light emitting unit controlled based on the third luminance value, wherein
the control unit uses a fifth luminance value obtained by adding a correction value to the third luminance value of the light emitting region whose luminance estimation value is smaller than the second luminance value based on a luminance characteristic of a region of the second subframe corresponding to each of the light emitting regions, to control the light emission of the aforementioned light emitting region.

12. The display device according to claim 11, wherein the correction value is obtained based on the third luminance value, the second luminance value, and the luminance estimation value.

13. The display device according to claim 11, wherein the correction value is determined based on a ratio between the second luminance value and the luminance estimation value of the light emitting region in which the correction value is added.

14. The display device according to claim 11, wherein the correction value is determined based on a ratio between the second luminance value and the luminance estimation value of the light emitting region in which the correction value is added, and the third luminance value of the light emitting region in the periphery of the light emitting region in which the correction value is added.

15. The display device according to claim 10, further comprising an estimation unit configured to obtain a luminance estimation value of the display unit corresponding to each of the light emitting regions in a case where the display unit is irradiated with light from the light emitting unit controlled based on the third luminance value, wherein
the control unit uses the second luminance value to control the light emission of the light emitting region whose luminance estimation value is smaller than the second luminance value.

16. The display device according to claim 1, further comprising:
a luminance estimation unit configured to estimate a luminance estimation value of light radiated to the display unit from the light emitting unit; and
a signal correction unit configured to carry out correction on at least one of the first subframe and the second subframe using the luminance estimation value.

17. A control method for a display device comprising a display unit configured to display an image on a screen based on an input frame, and a light emitting unit including a plurality of light emitting regions whose light emission is separately controllable and configured to irradiate the display unit with light, wherein
in a control process configured to control the light emission of each of the light emitting regions using luminance determined for each of the light emitting regions using the input frame, when the display unit displays a first subframe in which high-frequency components of the input frame are emphasized and a second subframe in which the high-frequency components of the input frame are suppressed by switching therebetween, the luminance determined using the input frame is applied to each of the plurality of light emitting regions during a period for which the first subframe is displayed and a period for which the second subframe is displayed such that the light emission is controlled.

18. The control method for the display device according to claim 17, wherein when the display unit displays the first subframe and the second subframe, the control process uses at least one of a first luminance value based on a luminance characteristic of a region of the first subframe corresponding to each of the light emitting regions and a second luminance value based on a luminance characteristic of a region of the second subframe corresponding to each of the light emitting regions to control the light emission of each of the light emitting regions.

19. The control method for the display device according to claim 18, wherein the control process uses a smaller luminance value among the first luminance value and the second luminance value to control the light emission of the light emitting region in which a difference between the first luminance value and the second luminance value is larger than a first threshold.

20. The control method for the display device according to claim 18, wherein the control process uses a smaller luminance value among the first luminance value and the second luminance value to control the light emission of the light emitting region in which the first luminance value and the second luminance value are smaller than a second threshold.

21. The control method for the display device according to claim 20, wherein the control process uses a larger luminance value among the first luminance value and the second luminance value to control the light emission of the light emitting region in which at least one of the first luminance value and the second luminance value is larger than the second threshold.

22. The control method for the display device according to claim 20, wherein the second threshold becomes larger as a setting value of display contrast of the display device becomes larger.

23. The control method for the display device according to claim 20, wherein the second threshold becomes larger as a setting value of maximum display luminance of the display device becomes larger.

24. The control method for the display device according to claim 20, wherein a ratio of the second threshold and a maximum value of an amount of light emission determinable by the control process becomes smaller as a setting value of maximum display luminance of the display device becomes larger.

25. The control method for the display device according to claim 20, wherein
the control process includes a threshold correction process configured to, in a case where a difference between a smaller luminance value among the first luminance value and the second luminance value of a certain light emitting region and a larger luminance value among the first luminance value and the second luminance value of a light emitting region adjacent to the certain light emitting region is larger than a predetermined value, increase the second threshold for the certain light emitting region, and
the control process controls the light emission of the certain light emitting region based on the second threshold.

26. The control method for the display device according to claim 17, wherein when the display unit displays the first subframe and the second subframe, the control process uses a third luminance value based on a luminance characteristic of a region of the input frame corresponding to each of the light emitting regions to control the light emission of each of the light emitting regions.

27. The control method for the display device according to claim 26, further comprising an estimation process configured to obtain a luminance estimation value of the display unit corresponding to each of the light emitting regions in a case where the display unit is irradiated with light from the light emitting unit controlled based on the third luminance value, wherein
the control process uses a fifth luminance value obtained by adding a correction value to the third luminance value of the light emitting region whose luminance estimation value is smaller than the second luminance value based on a luminance characteristic of a region of the second subframe corresponding to each of the light emitting regions, to control the light emission of the aforementioned light emitting region.

28. The control method for the display device according to claim 27, wherein the correction value is obtained based on the third luminance value, the second luminance value, and the luminance estimation value.

29. The control method for the display device according to claim 27, wherein the correction value is determined based on a ratio between the second luminance value and the luminance estimation value of the light emitting region in which the correction value is added.

30. The control method for the display device according to claim 27, wherein the correction value is determined based on a ratio between the second luminance value and the luminance estimation value of the light emitting region in which the correction value is added, and the third luminance value of the light emitting region in the periphery of the light emitting region in which the correction value is added.

31. The control method for the display device according to claim 26, further comprising an estimation process configured to obtain a luminance estimation value of the display unit corresponding to each of the light emitting regions in a case where the display unit is irradiated with light from the light emitting unit controlled based on the third luminance value, wherein
the control process uses the second luminance value to control the light emission of the light emitting region whose luminance estimation value is smaller than the second luminance value.

32. The control method for the display device according to claim 17, further comprising:
a luminance estimation process configured to a luminance estimation value of light radiated to the display unit from the light emitting unit controlled through the control process; and
a signal correction process configured to carry out correction on at least one of the first subframe and the second subframe using the luminance estimation value.

33. A program configured to cause a processor to carry out the control method for the display device according to claim 17.

34. A storage medium from which the program according to claim 33 is readable by a processor.
